(19) United States
(12) Patent Application Publication
(10) Pub. No.: US 2016/0156754 A1
(43) Pub. Date: Jun. 2, 2016

(54) Cell phone case with illuminated magnifier

(71) Applicant: Manuel Cotelo, Toms River, NJ (US)

(72) Inventor: Manuel Cotelo, Toms River, NJ (US)

(21) Appl. No.: 14/757,166

(22) Filed: Nov. 30, 2015

Related U.S. Application Data
(63) Continuation-in-part of application No. 13/679,904, filed on Nov. 16, 2012, now abandoned.

(51) Int. Cl. H04M 1/02; H04B 1/3888; H04M 1/21; G02B 25/00; G02B 25/02

(52) U.S. Cl. CPC H04M 1/027; G02B 25/005; G02B 25/02; H04M 1/21; H04B 1/3888

(57) ABSTRACT

A cellular phone case or case cover is provided having a magnifying glass that can extend from and be returned into one side of the case. The magnifying glass can be illuminated by a light emitting diode (LED) so that a person can read in any environment or lighting condition. The electronic device case can have its own integrated power source so as not to remove power from the electronic device.

### RELATED APPLICATIONS

There present invention is a Continuation in Part of U.S. Ser. No. 13/679904, filed on Nov. 16, 2012 and incorporated by reference as if fully rewritten herein.

### BACKGROUND OF THE INVENTION

1. Field of the Invention

The present invention relates to cases of covers for electronic device such as cellular phones or smart phones and, more particularly, to a cellular phone or smart phone cover or case that may contain a magnifying glass and lightning element in a deployable and retractable manner.

2. Description of the Related Art

Presbyopia is one condition associated with aging. It this condition the eye exhibits a progressively diminished ability to focus on near objects. While an exact mechanism is not fully understood, the first signs of presbyopia—eyestrain, difficulty seeing in dim light, problems focusing on small objects and fine print—are usually first noticed between the ages of 40 and 50.

Whether through presbyopia, or other aging or medical related conditions, many adults eventually can have difficulty reading small print, such as details on a menu in a dimly lit restaurant, package ingredients in a grocery store, or other such material. The first symptoms most often notices are difficulty reading fine print, particularly in low light conditions, eyestrain when reading for long periods, blur at near or momentarily blurred vision when transitioning between viewing distances. Many extreme presbyopes complain that their arms have become “too short” to hold reading material at a comfortable distance.

Most people today carry cell phones with them wherever they go. As technology progresses, these phones, often called smart phones, can be programmed with applications that can perform various functions. One such application is a built-in magnification application that can magnify text, input via the phone's camera, and display the text, appropriately enlarged and illuminated, on the display screen.

This technology, however, requires the text to be displayed onto the screen in order to utilize such magnification applications. As such, it is not useful when used in conjunction with printed text.

Solutions to solve the problem of reading small print include carrying a magnifying glass or other similar magnification device. This solution, however, requires the user to have a separate item when can be easily lost or forgotten.

As can be seen, there is a need for a magnification device that can be used in conjunction with or integrated to a user's cellular phone electronic device that provides magnification and/or illumination onto separate printed material.

### SUMMARY OF THE INVENTION

According to one aspect of the present invention, a removably attachable case for a cellular phone device is provided comprising a phone case main body having a telescoping magnifier unit operable between a first position, secured between a false bottom and a bottom portion of the case, and a second position, extending outward from a slot defined between the false bottom and the bottom portion. Additionally, a light is provided adapted to be operable to illuminate when the magnifier unit is disposed in the second position.

According to another aspect of the present invention, the telescoping magnifier unit may be integrated operably within the housing of the cellular phone device itself.

In any aspect of the present invention, at least one light emitting diode may be operable to illuminate when the magnifier unit is disposed in the second position. In any aspect of the present invention, a spring may be operably incorporated in a manner that urges the magnifier unit in the second position upon engagement of a release button. The release button may have a prong operable to engage a detent in the magnifier unit to retain the magnifier unit in the first position.

These and other features, aspects and advantages of the present invention will become better understood with reference to the following drawings, description and claims.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an electronic device case, in use with an electronic device, having an illuminated magnification device in a deployed configuration;

FIG. 2 is an exploded perspective view of the electronic device case of FIG. 1, with the illuminated magnification device in a stored configuration;

FIG. 3 is a cross-sectional view taken along line 3-3 of FIG. 2, with the illuminated magnification device in a deployed configuration;

FIG. 4 is a cross-sectional view taken along lien 3-3 of FIG. 2, with the illuminated magnification device in a stored configuration;

FIG. 5 is a detailed cross-sectional view taken along line 5-5 of FIG. 3; and

FIG. 6 is a detailed cross-sectional view taken along line 6-6 of Figure.

### DESCRIPTION OF THE PREFERRED EMBODIMENTS

The best mode for carrying out the invention is presented in terms of its preferred embodiment, herein depicted within the Figures. For purposes of enabling a preferred embodiment an aspect is shown and described in which a separably attachable phone case cover is depicted. However, it should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. This may include, inter alia, the aspect in which the features and functions are incorporated directly within the casing of a cellular phone itself. As such, it should be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The best mode for carrying out the invention is presented in terms of its preferred embodiment, herein depicted within the Figures. The description is not to be taken in a limiting sense, but is made merely for the purpose of illustrating the general principles of the invention, since the scope of the invention is best defined by the appended claims.

### 1. Detailed Description of the Figures

Broadly, an embodiment of the present invention provides a removable cellular phone case that has a magnifying glass that can extend from and be returned into one side of the case. The magnifying glass can be illuminated by a light emitting diode (LED) so that a person can read in any environment or lighting condition. The electronic device case can have its own integrated power source so as not to remove power from the electronic device. The electronic case can be designed as a slim profile case for various devices, such as smart phones, e readers, tablets, and other similar devices.

Further, for purposes of the present invention the integration of the magnifying structures directly into the housing of the cellular phone, rather than a separate removable cell phone cover, should be considered within the range of equivalents of the present invention.

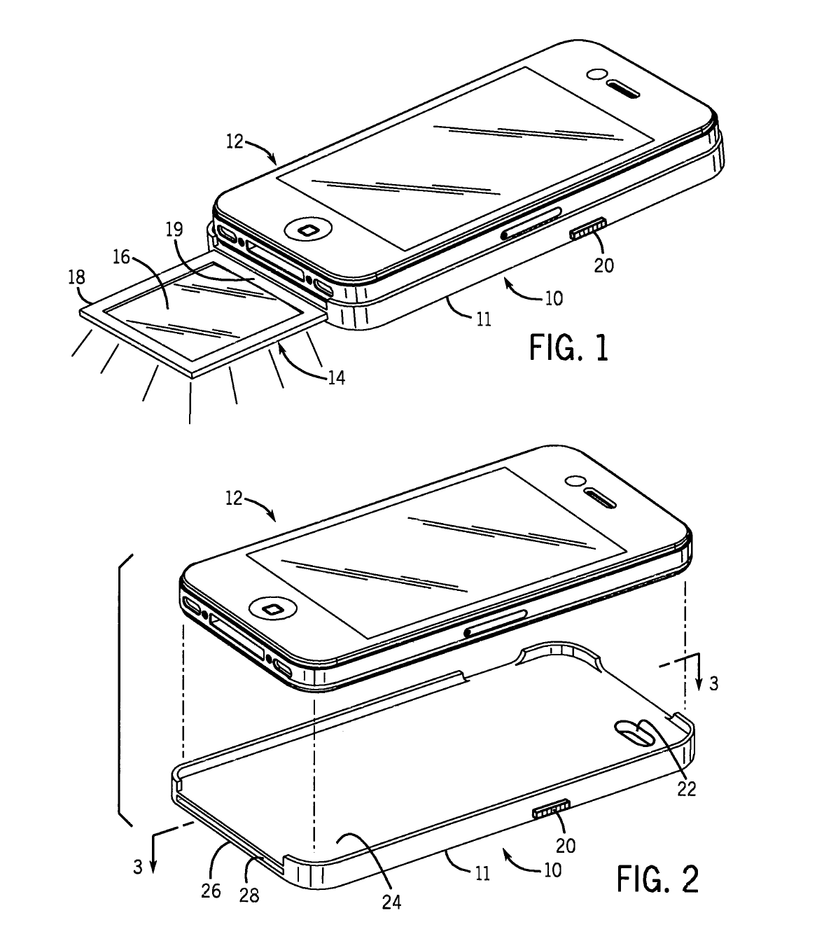

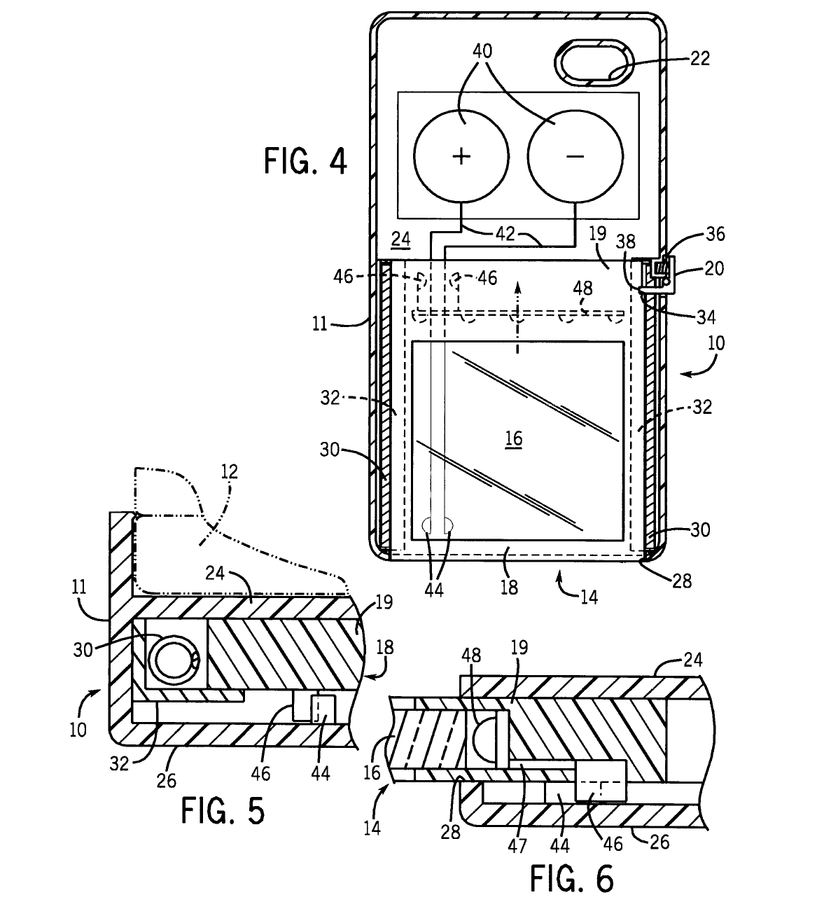

Referring now to FIGS. 1 through 6, a cell phone case, generally noted as 10, is shown according to one aspect of the preferred embodiment of the present invention. The case 10 may be designed to hold and protect a smart phone 12 by removably affixed to the rear of the phone housing. The cell phone case 10 can be designed to permit the usual functions of the smart phone 12 by, for example, including a camera lens aperture 22 within the main body 11 of the cell phone case 10. The smart phone 12 can fit into the cell phone case 10, against a false bottom 24 of the main body 11.

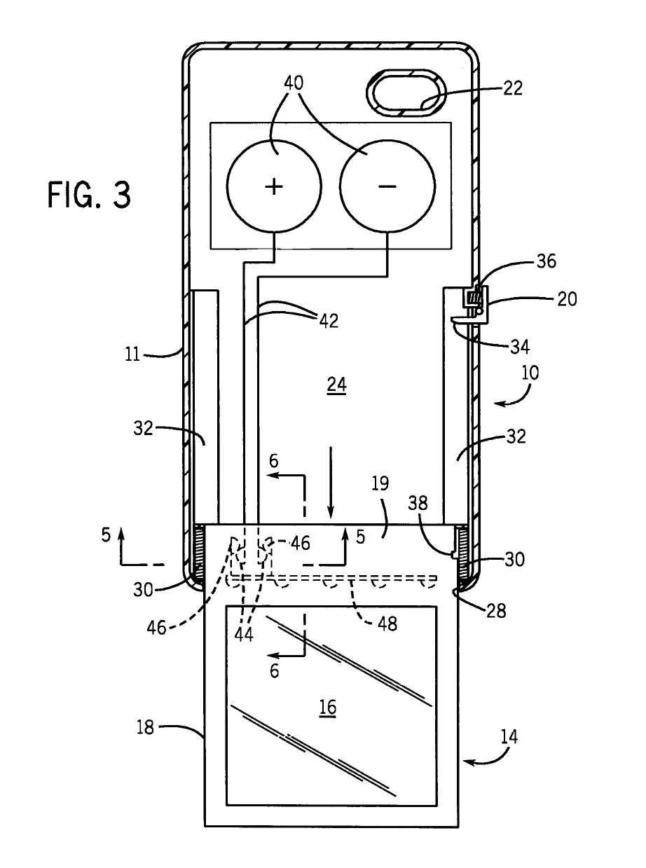

As shown in greater detail in conjunction with FIG. 1, a magnifier unit 14 can telescopingly extend from a slot 28 formed in one side of the cell phone case 10, between the false bottom 24 and a bottom 26 of the main body 11. A button 20 can be disposed on one or more sides of the cell phone case 10 to release a catch (described below) and allow the magnifier unit 14 to extend from the slot 28. Typically, the slot 28 can be disposed on a top or bottom side of the cell phone case 10 and the button 20 can be disposed on one side of the cell phone case 10, as shown in FIG. 3, or may be disposed on both sides of the cell phone case 10, where both buttons 20, on each side, must be depressed to release the magnifier unit 14, thereby reducing the chance of accidental deployment. The button 20 can include a compression spring 36 to keep the button in an engaged position, where pressing the button 20 moves a prong 34 of the button 20 from engagement of a detent 38 in the distal end 1901 the magnifier unit 14.

The magnifier unit 14 can include a frame 18 surrounding a magnifier 16. A distal end 19 of the magnifier unit 14 can include a LED ribbon 48, as described in greater detail below.

Power can be provided to an LED ribbon 48 with one or more batteries 40. Typically, the batteries 40 can be button batteries designed to fit below the false bottom 24 of the body 11 adjacent to an area containing the magnifier unit 14 when in a stored position.

The power can be carried by conductors 42 from the batteries 40 to contacts 44 disposed in the cell phone case 10. When the magnifier unit 14 is extended from the slot 28 (by pushing the button 20), contacts 46 of the magnifier unit 14 can contact contacts 44 of the conductors 42 to electrically connect the contacts 44, 46. The contacts 46 of the magnifier unit 14 are electrically connected to the LED ribbon 48, thereby illuminating the LED ribbon when the magnifier unit 14 is extended from the slot 28.

The magnifier unit 14 can be extended out of the slot 28 through the force of springs 30. When the user wants to store the magnifier unit 14, they can press in the magnifier unit 14 against the force of the springs 30 to lock the detent 38 in the distal end 19 of the magnifier unit 14 into the prong 34 of the release button 20. Typically, a spring 30 can be disposed on each side of the magnifier unit 14. The spring 30 can be made of various materials, including plastic, composite or metal, such as aluminum or stainless steel.

The springs 30 can be disposed in a channel, adjacent the magnifier unit 14, defined at least partially by a guide rail 32. The guide rail 32 can be an L-shaped member that can support the frame 18 of the magnifier unit 14.

The cell phone case 10 can be custom molded to fit various styles and designs of electronic devices, such as smart phones, including the iPhone® by Apple®. The cell phone case 10 can be molded to a uniform thickness as dictated by the type of battery required to power the LED light. Typically, the LED ribbon 48 can be mounted on the bottom edge of the magnifier 16 and automatically turns on when the magnifier unit 14 is extended from the cell phone case 10.

### 2. Operation of the Preferred Embodiment

In operation, the cell phone case 10 can be made from various conventional methods and from various materials. Typically, the cell phone case 10 can be fabricated by a mold facility based upon the design. Alternately, it is envisioned that a magnifier as otherwise taught herein may be incorporated directly into the housing of the cell phone itself.

Depending on the manufacture technique, various components can be molded integrally, or molded separately and connected together.

To use the cell phone case 10 of the present invention, a user can simply insert their electronic device, such as their smart phone 12, into the cell phone case 10 and use their smart phone 12 as usual, knowing that the case also helps protect their smart phone 12. When the user needs a magnifier, they can simply press a small button (release button 20) on the side of the cell phone case 10 to release the magnifier unit 14 from the slot 28. Under the force of the springs 30, the magnifier unit 14 will pop out of the slot 28 and fully extend to a use position.

In addition, as the magnifier unit 14 is fully extended, electrical connections can be established to permit illumination of the LED lights (LED ribbon 48) disposed to illuminate an area being magnified through the magnifier 16 of the magnifier unit 14.

The magnifier unit 14 can be made in various sizes and shapes. Typically the magnifier unit 14 is rectangular or square. In some embodiments, the magnifier unit 14 can be made as a 2-inch by 2-inch square, however, if a larger electronic device is used with the cell phone case 10, larger magnifier units 14 may also be used.

While the above refers to the use of a cell phone case 10 adapted for use with a smart phone 12, the present invention can be applied to cases for various electronic devices, including not only smart phones, but also tablets, e-readers, or the like.

The foregoing descriptions of specific embodiments of the present invention are presented for purposes of illustration and description. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and

Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this Patent Application.

What is claimed is:

1. In combination:
an otherwise conventional cellular telephone having a liquid crystal display (LCD) on a front surface and an engageable illumination element on a rear surface; and
a magnifying unit operable between a first retracted position and a second extended position;
wherein said magnifying unit is adapted for viewing images directed under illumination generated by said illumination element when in said second extended position.

2. The combination of claim 1, wherein said magnifying unit is operably incorporated within a separable cell phone cover.

3. The combination of claim 2, wherein the magnifier unit comprises:
a frame surrounding a magnifier lens;
conductor contacts disposed in the case, the conductor contacts connected to the power source via conductors; and
magnifier unit contacts disposed on the magnifier unit, wherein the conductor contacts electrically connect with the magnifier unit contacts when the magnifier unit is in the second position.

4. The combination of claim 1, wherein said magnifying unit is integrated with and operably incorporated within a cell phone housing.

5. The combination of claim 2, wherein said magnifying unit comprises a magnifying lens secured between a false bottom and a bottom portion of the cell phone cover, wherein said in said second position said magnifying lens extends outward from a slot defined between the false bottom and the bottom portion.

6. The combination of claim 2, wherein said cell phone cover further comprises:
a power source includes one or more batteries; and
a second light including at least one light emitting diode and in electrical communication with and powered by said power source.

7. The combination of claim 5, wherein said cell phone cover further comprises:
a power source includes one or more batteries; and
a second light including at least one light emitting diode and in electrical communication with and powered by said power source.

8. A removably attachable case for a cellular phone device comprising:
a phone cover main body designed to hold and protect a smart phone by removably affixed to a rear of a phone case main body;
a telescoping magnifier unit operable between a first position, secured between a false bottom and a bottom portion of the phone cover main body, and a second position, extending outward from a slot defined between the false bottom and the bottom portion;
wherein said removably attachable case is further designed to permit the usual functions of the smart phone while still allowing said smart phone to fit into the cell phone case against said false bottom of said main body.

9. The removably attachable case for a cellular phone device of claim 8, further comprising a light integrated within said phone case main body and adapted to be operable to illuminate when the magnifier unit is disposed in the second position.

10. The removably attachable case for a cellular phone device of claim 9, wherein said phone case main body further forms an illumination orifice for providing free access of a light integrated within said cell phone such as to be operable to illuminate when the magnifier unit is disposed in the second position.

11. The removably attachable case for a cellular phone device of claim 8, further comprising a light integrated within said phone case main body and adapted to be operable to illuminate when the magnifier unit is disposed in the second position.

12. The removably attachable case or a cellular phone device of claim 8 further forming a camera lens aperture within the main body of the cell phone case.

13. The removably attachable case of a cellular phone device of claim 8 further comprising a deployment button disposed on one or more sides of the cell phone case to release a catch that allows the magnifier unit to extend from the slot, wherein as said button is depressed said magnifier unit is deployed.

14. The removably attachable case of a cellular phone device of claim 13, further comprising a compression spring to keep the button in an engaged position, where pressing the button moves a prong of the button from engagement of a detent in the distal end of the magnifier unit.

15. A method for providing a personal viewing magnifier, said method comprising the steps:
a. obtaining a magnifying unit operable between a first retracted position and a second extended position; and
b. positioning said magnifying unit about a rear surface of a cellular telephone;
wherein said magnifying unit is adapted for viewing images directed under illumination generated by said illumination element when in said second extended position.

16. The method of claim 15, wherein magnifying unit is incorporated in a separable case for covering a cellular phone and further comprising:
a case main body having a false bottom operable to support the cellular phone;
a power source disposed in the case; and
said magnifier unit operable between a first position, secured between the false bottom and a bottom portion of the case, and a second position, extending outward from a slot defined between the false bottom and the bottom portion.

17. The method of claim 16, wherein said case for covering a cellular phone further comprises:
a light operable to illuminate when the magnifier unit is disposed in the second position, the light powered by the power source.

18. The method of claim 17, wherein said case for covering a cellular phone further comprises a power source including one or more batteries in electrical communication with said light.
